(19) United States
(12) Patent Application Publication
(10) Pub. No.: US 2007/0199973 A1
(43) Pub. Date: Aug. 30, 2007

(54) Tubular filter material machine and methods

(76) Inventors: Ruediger Tueshaus, Dorsten (DE); Peter Rossler, Hamm (DE)

Correspondence Address: KENNETH L. NASH, P.O. BOX 680106, HOUSTON, TX, 77268-0106, US

(21) Appl. No.: 11/376,073

(22) Filed: Mar. 15, 2006

Related U.S. Application Data
(60) Provisional application No. 60/777,108, filed on Feb. 27, 2006.

(51) Int. Cl. B23K 37/00; B21D 39/00

(52) U.S. Cl. 228/17.7; 228/4.1; 228/145

(57) ABSTRACT

A machine for continuously making spirally wrapped tubular filter material screens utilizes a mandrel around which one or more strips of filter material are wrapped. The resulting spirally wrapped tubular filter material screen may or may not comprise multiple layers of filter material. In one embodiment, the strips of filter material are continuously resistance welded along or about the helical seams of the filter material strips utilizing an outer welding wheel and an inner welding wheel.

This application claims benefit of U.S. Provisional Application No. 60/777,108 filed Feb. 27, 2006, which is incorporated herein in its entirety.

### BACKGROUND OF THE INVENTION

1. Field of the Invention

The present invention relates generally to tubular filter material assemblies and, more particularly, to apparatus and methods for continuously or intermittently bonded spiral wound tubular filter material assemblies and/or machines for making tubular filter material assemblies.

2. Description of the Background

Tubular filtering screens may comprise steel, plastic, or other filter materials. For instance, tubular filter material screens comprised of wire mesh filter material may be used in oil field well bores for downhole sand control. When used downhole for sand control purposes, the tubular screen might be part of a gravel packing construction around the well bore in a pay zone of interest to limit the flow of sand into the wellbore, and thereby extend time of operation of the well.

When welding tubular filter screen material together, TiG and MiG welding may damage wire mesh and produce holes in the sand control tubular screen which permit leakage through the screen. Resistance welding has not been particularly useful for tubular screens of any significant length because of the need for an interior electrode.

In some cases, tubular screens are manufactured by wrapping filter material around a perforated body. However, these tubular screens are problematic in that the screens cannot be inspected using techniques such as passing a light through the center of the screen. Therefore, the quality is dubious. As noted above, filter material is very difficult to weld. In some types of filter material, a hole can be formed with the flame from a cigarette lighter. Welds that cannot be checked are problematic due to the possibility of leaks after incurring the high costs of placing such screens downhole. Thus, in many cases, tubular screens formed by wrapping filter material around a support tubular such that the screens are permanently secured to the support tubular are not acceptable due to the inability to make quality checks of the filter material screens. As well, this type of construction is not flexible for logistical purposes. It may often be desirable that the tubular screen and the pipe be separately made and assembled at another desired location to offset the transportation cost logistics.

Screens may also be made with woven screens dipped or covered with sintered metal particulates which are then spirally wrapped around support tubulars and welded, but this construction is expensive and also prevents the possibility of quality checks that utilize a light passing though the interior of the screen to verify the absence of holes produced by welding.

While tubular or cylindrical mesh screens which are not built on perforated forms are well known, these prior art tubular filter material screens are time consuming to build and quite expensive. These tubular filter material screens are formed in sheets having a selected but limited length. The sheets are rolled to form a tubular of the selected length, and then welded along the longitudinal seam. The tubular screen can then be inspected such as by passing a light through the center of the screen to check for imperfections. However, the straight lengthwise weld of the filter material requires significant expertise to make and is time consuming and costly, even if the weld is made by machine. It will also be understood that this assembly first requires obtaining one or more sheets of filter material having the desired dimensions for the cylindrical screen to be created. Because the sheets of mesh screens may be limited in size, and due to the difficulties of welding along the length of the screens, in many cases several cylindrical mesh tubes must be welded to end caps which are then secured together to form a cylindrical screen of the desired length.

The above cited art provides filter screens that have significant cost problems, quality problems and/or logistics problems. Consequently, there remains a long felt need for improved methods for more quickly making such screens at lower costs. Those skilled in the art have long sought and will appreciate the present invention which addresses these and other problems.

### SUMMARY OF THE INVENTION

It is an object of the present invention to provide an improved tubular screen and a machine for making the improved tubular screen.

It is yet another object of the present invention to provide a tubular screen that may be made in an automatic continuous or endless process such that the tubular screen can be simply cut off at any desired length.

It is yet another object of the present invention to provide means for quickly and continuously or intermittently bonding spiral wrapped cylindrical screens of any length.

It is yet another object of the present invention to provide a means for forming the screen in a continuous manner so that it is initially self-supporting without the need to permanently form and weld or otherwise bond the tubular filter material screen on a metallic support tubular thereby permitting for more stringent internal quality checks.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the present invention comprises a machine for making a spiral wrapped filter material tubular screen from one or more strips of filter material. The machine may comprise a mandrel with an outer surface and at least one filter material strip feed to deliver one or more filter material strips onto the outer surface of the mandrel such that the one or more filter material strips are directed onto at least a portion of the outer surface of the mandrel for forming a shape of the filter material tubular screen. In one possible preferred embodiment, the filter material moves continuously around the mandrel and the mandrel remains static. In one embodiment, an exterior bonding element such as a welding electrode may be positioned outside the exterior filter material surface and an interior bonding element such as a welding electrode may be positioned along the interior filter material surface of the one or more filter material strips. If utilized, the interior welding electrode may cooperate with the exterior welding electrode for welding the one or more wire strips together, such as by resistance welding.

The mandrel may further comprise a tubular and at least a portion of the interior welding electrode may be positioned within an interior of the tubular. The mandrel may further comprise a mandrel opening in the outer surface of the mandrel and the interior welding electrode may be positioned within the opening. In one embodiment, the opening may comprise a curved slot. The interior welding electrode may comprise at least one inner welding wheel. The inner welding wheel may or may not be driven to thereby spirally move or assist in moving the one or more filter material strips around the outer surface of the mandrel as the one or more filter material strips are continuously spirally welded together. In one embodiment, the outer welding electrode comprises at least one outer welding wheel and may comprise one or more electrically insulated disks.

The machine may further comprise a filter material strip drive which frictionally engages the one or more filter material strips to spirally wrap the one or more filter material strips around the mandrel and past the outer welding electrode and the inner welding electrode such that the one or more filter material strips are continuously spirally welded together. In one possible embodiment, the machine may also comprise at least one feed for at least one strip of paper or other insulating or friction reducing material along with wire mesh to insulate wire mesh from a metallic mandrel and to permit easy movement of the wire mesh around the mandrel. The machine may comprise means for continuously moving and continuously spirally wrapping the one or more strips of filter material around the mandrel.

A method is provided for making a spiral wrapped filter material tubular screen from one or more strips of filter material which may comprise continuously spirally forming a tubular with the one or more strips of filter material. Other steps may comprise continuously or non-continuously spirally bonding the one or more strips of filter material such that a spirally bonded length of the spirally wrapped tubular screen moves continuously axially or at least moves with an axial directional velocity vector component. The method may further comprise continuing to produce the spirally wrapped tubular screen until a desired length is reached.

Another method for making a tubular screen of a desired length may comprise spirally wrapping a woven mesh screen to form the tubular screen, continuously welding the spirally wrapped woven screen, and cutting the tubular screen to the desired length.

One embodiment of the present invention comprises a tubular screen which may comprise one or more elements, such as a woven metallic or other type of filter material screen, which may comprise a plurality of filter material strips such as woven mesh strips secured together with at least one continuous, nearly continuous, or intermittent, or series of spot bonds or welds, which may in one embodiment, comprise spiral or spirally aligned bonds such as electro-resistance welds. One or more bonding machines may be utilized. In one embodiment with wire mesh, if desired, the woven screen may be constructed without adding any or any substantial amount of metal particles to the screen prior to being welded together. If desired, the plurality of woven mesh strips may be welded together with at least one continuous spiral electro-resistance weld. The woven metallic screen may comprise one or more spiral seams between the plurality of woven mesh strips. A spiral electro-resistance weld may be made so as to be coincident, parallel, or substantially parallel to the spiral seams between a plurality of woven mesh strips. The tubular screen might further comprise a plurality of continuous spiral electro-resistance welds which may be parallel with respect to each other.

In another embodiment, the tubular screen may comprise a plurality of layers of filter material strips. The filter material may comprise woven filter material, plastic material, woven plastic material, metal fiber, extruded mesh, sintered, extruded mesh, or other desired filter materials. The continuous tubular screen may be any length and may be a long length, such as a length greater than ten feet. In one embodiment, the tubular screen is at least five feet long and is formed by cutting off the tubular screen from a longer tubular screen.

The tubular screen may be self supporting so as to comprise one or more of the plurality of woven mesh strips along the inner surface thereof and avoid the need for a support tubular. For instance, instead of a support tubular, the tubular filtering screen may comprise an innermost surface which itself is a spirally wrapped woven wire screen comprising a plurality of woven wire strips that may be continuously bonded together along a spiral bonding path.

### BRIEF DESCRIPTION OF THE DRAWINGS

FIG. 1 is an elevational view, in section, showing an inner welding wheel supported at a first angle with respect to a tubular screen and mandrel in accord with one possible embodiment of the present invention;

FIG. 2 is a plan view in section showing the inner welding wheel supported at an angle related to the angle of the helical seam of the filter material ribbons to be welded together which is a function of the mandrel diameter and width of filter material ribbons to be welded together in accord with one possible embodiment of the present invention;

FIG. 3 is a plan schematic view, with internal wheel shown, of a tubular filter material construction machine with filter material and which may also utilize paper strips or other friction reducing material being continuously fed onto a mandrel and rotated around the mandrel for welding together to form an endless cylinder in accord with one possible embodiment of the present invention;

FIG. 4 is an elevational view, partially in section, of relevant portions of a tubular filter material construction machine comprising dual outer welding wheels, a single inner welding wheel, a mandrel, and a support stand in accord with one possible embodiment of the present invention;

FIG. 5 is an elevational view of a frame supporting a mandrel and outer welding wheel viewed along lines 5-5 of FIG. 4 in accord with one possible embodiment of the present invention;

FIG. 6 is a plan view looking down on the machine of FIG. 4 wherein details of the dual outer welding wheels and support therefore may be seen in accord with one possible embodiment of the present invention:

FIG. 7 is a perspective simplified view of a tubular filter material construction machine showing a configuration for an outer welding wheel, inner welding wheel, and tubular mandrel in accord with one possible embodiment of the present invention;

FIG. 8 is an elevational view of a spiral wrapped continuously bonded tubular filter material screen that may be of any length and may be freestanding without the need for an inner support tubular in accord with the present invention; and

FIG. 9 is an elevational view in section of a spiral wrapped continuously bonded tubular filter material screen positioned within an outer tubular in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

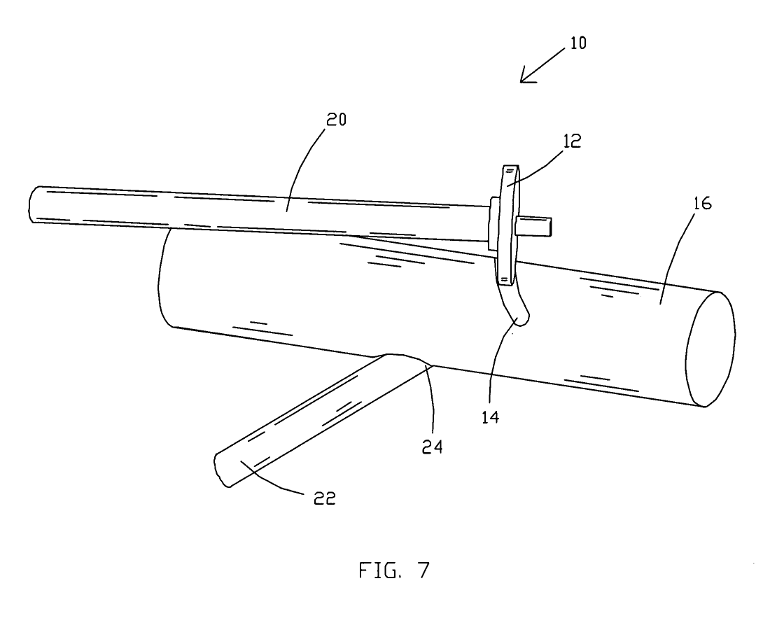

Referring now to the figures, and more particularly to FIG. 7, there is shown an overview of presently preferred basic components of machine 10 for making a filter material cylindrical screen in accord with one possible embodiment of the present invention. The machine is operable to make endless spiral wrapped continuously bonded tubular filter material screens which may or may not comprise multiple layers of filter material and, in this embodiment, are continuously resistance welded along the helical seams of filter material strips comprising woven wire which are utilized within this particular tubular screen.

In a presently preferred embodiment, the welding electrodes may, if desired, be designed as wheels such as outer welding roller or wheel 12. However, the invention is not limited to use of welding wheels and could use any type of welding electrodes or bonding devices.

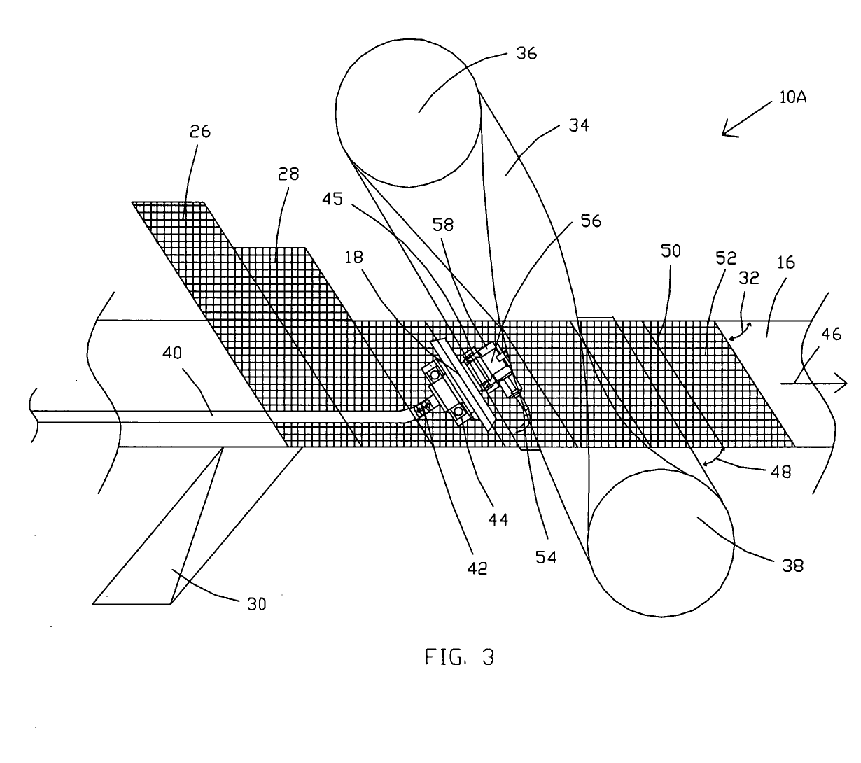

As shown in FIG. 7, outer welding wheel 12 is positioned over slot 14 on mandrel 16. As used herein, a mandrel is a tool used as a form or to form a work or in this case a filter material tubular. Outer welding wheel 12 cooperates with inner welding roller or wheel 18 (which may be seen for instance in FIG. 1). Inner welding wheel 18 is positioned in slot 14 opposite outer welding wheel 12 for welding ribbons or strips of woven filter material. As discussed subsequently in connection with FIG. 3, ribbons or strips of woven filter material, such as ribbons 26 and 28, comprise at least one filter material strip feed to direct the filter material strips or ribbons onto mandrel 16 whereupon they are spirally driven around mandrel 16 between outer welding wheel 12 and inner welding wheel 18 and are thereby spirally welded together at or adjacent the seams thereof.

Utilizing resistance welding in accord with one embodiment of the present invention helps mitigate damage to the filter material screens during the welding process. Also in accord with embodiments of the present invention, the weld may form one or more continuous helical weld beads or lines which secure the ribbons or strips of filter material together. The ribbons or mesh to be welded may be abutting or overlapped by a selected amount as desired. One or more corresponding welded seams are formed which permanently secure the ribbons together.

Outer shaft 20 rotatably supports outer welding wheel 12. Inner shaft 22 rotatably supports inner welding wheel 18. Outer shaft 20 and/or inner shaft 22 may or may not be driven to thereby assist in moving filter material strips around mandrel 16. Many variations of outer shaft 20 and inner shaft 22 are possible some of which are shown herein. For instance, inner shaft 22 may or may not extend through the side of mandrel 16. However, in the embodiment shown in FIG. 7, inner shaft 22 extends through opening 24 in mandrel 16. Outer shaft 20 and inner shaft 22 may or may not be parallel or aligned.

For resistance welding, electric current flows between outer welding wheel 12 and inner welding wheel 16 through slot 14 and may flow in different current paths and/or directions and/or through the ribbons more than once, as discussed below.

Slot 14 in mandrel 16 may preferably be curved. A curved design for slot 14 provides several advantages. One advantage is that the space between the edges of slot 14 and the outer edges of the welding wheels can thereby be kept as small as possible so that mandrel 16 provides good support for the portion of the filter material strips to be welded by outer welding wheel 12 and inner welding wheel 18.

As well, it will be appreciated that adjustments in the angle of welding may also be desirable and accommodated by the curve in slot 14. The coiling-angle α is a function of mandrel 16 diameter D and filter material ribbon width B so that a may be equal to or proportional to sin B/(D*π).

The coiling-angle is the angle of the helix or seam of the mesh ribbons to be welded together with respect to the centreline of the coil. As noted in FIG. 3, the filter material strips may preferably be fed onto mandrel 16 as close as possible to the desired coiling angle. The ribbon width B may effectively vary depending not only on the actual width of the ribbon strips or filter material but also whether the seams are abutting or overlapping and/or the amount of overlap. The effective diameter D of mandrel 16 depends on the diameter of mandrel 16 but may also effectively vary due to the number of layers of filter material and the thickness of each filter material layer.

The present invention is not limited to any particular mechanical construction for alignment and/or adjustment of inner wheel 16 and outer wheel 12 with respect to the coiling angle because many possible constructions may be utilized in accord with the present invention depending on the desired filter material cylinder to be produced. For instance, the relative positions of outer wheel 12 and/or inner wheel 16 may or may not be fixed, movable, and/or controlled or adjustable manually or under computer control as desired and depending on the desired flexibility of operation for machine 16 with respect to different types of filter material cylinders to be produced. Depending on the desired flexibility of operation, machine 10 may be designed for welding filter material strips of a particular width and seam abutment and/or seam overlap or may be designed to permit variations thereof as desired. As well, depending on the desired flexibility of operation and the subsequent complexity of machine 10, other variations for positioning of inner wheel 16 and outer wheel 12 are available. For instance, inner wheel 16 may be variable only in a direction radially outwardly and inwardly and/or there may be slight differences in the angular alignment of inner wheel 16 and/or outer wheel 12 and/or the coiling angle. Such variations may also change depending on the type of filter material involved. For instance, the alignment requirements for woven mesh formed of round wires may be different than the alignment requirements for woven mesh formed of flat wires. It will also be understood that machine 10 may allow for replacement of mandrel 16 with different diameter mandrels and/or may provide for a variable diameter mandrel, e.g., mandrel 16 may be built with linear strips or segments adjustably mounted (not shown) so that the effective diameter thereof may be expanded or contracted radially outwardly or inwardly to produce different diameter filter material tubulars.

FIG. 3 is a plan schematic view which shows the general layout for tubular filter material construction machine 1A. In this embodiment, filter material strips 26 and 28 and paper strip 30 are being continuously fed onto mandrel 16 and rotated around the mandrel 16 for welding together to form an endless spirally wrapped filter material cylinder 32 in accord with one possible embodiment of the present invention. Endless spirally wrapped filter material 32 moves in the direction of arrow 46 over and past mandrel 16. Accordingly, the so-created filter material tubular can be conveniently cut to any desired length. Additional ribbons of filter material may also be utilized so that the present design is not limited to two filter material ribbons and may utilize any desired number of strips. For instance, as one possibility, three filter material strips and one paper ribbon might be wound around mandrel 16 at an angle of 14.5° (not shown).

Belt 34 and pulleys 36 and 38 wrap around filter material cylinder 32 and frictionally engage filter material cylinder 32 for rotating it around mandrel 16. Belt 34 may be angled as desired and in this embodiment is slightly offset with respect to the angle of welded seam 50. For instance, in this embodiment, angle 48 of engagement of endless belt 34 with filter material cylinder 32 is approximately 58 degrees whereas angle 52 of welded seam 50 is somewhat less at 45 degrees. As noted above, outer welding wheel 12 and/or inner welding wheel 18 may be used with and/or replace other types of drives. Other types of drives such as rubber wheels, belts, built-in drive sections on mandrel 16, internal wheels with additional slots in mandrel 16, or the like may also be used as desired for rotating filter material cylinder 32 around mandrel 16.

Insulative or friction reducing material strip 30, such as paper or other suitable materials, may be used as an electrical insulator and may also be selected to reduce the friction of rotating the so created filter material cylinder 32 around mandrel 16. Paper strip 30 is preferably smaller in width than the widths of filter material strips 26 and 28 to thereby provide a continuous slot on the inner surface of the combined strips 26, 28, and 30 whereby access to filter material strips 26 and 28 is available to inner welding wheel 18 for resistance welding purposes. Except for the continuous slot, paper strip 30 electrically insulates filter material cylinder 32 from mandrel 16 so that little or no electrical current preferably passes between filter material cylinder 32 and mandrel 16. As well, mandrel 16 could possibly be made of electrically insulating materials or compounds rather than metal, although metal is a relatively easily available and low-cost material that provides a long lasting mandrel.

In the embodiment shown in FIG. 3, the interior workings of one possible embodiment of inner welding wheel 18 are shown through the filter material and mandrel where inner welding wheel 18 is mounted inside the interior of mandrel 16. In this embodiment, inner welding wheel 18 may be driven by shaft 40 and universal joint 42 to help rotate the filter material being welded together. Inner welding wheel 18 is supported for low friction by bearing assembly 44 and bearing assembly 45.

In this embodiment, but not in all embodiments, electrical power to inner welding wheel 18 may be provided via cable 54 where it is connected to inner welding wheel shaft 56 through cylinder 58. Cable 54 could be shorted to mandrel 16 or may be connected to a power supply as desired. In other embodiments, no cable is needed. For instance, as discussed below for use with a double disk outer welding wheel 12 described hereinbelow, wheel 18 provides a shorting connection between the double disks and therefore no cable is needed.

FIG. 1 shows inner welding wheel 18 supported internally within mandrel 16 in accord with one possible embodiment of the present invention. In this embodiment, welding wheel 18 is mounted on support 62 (which may or may not extend through mandrel 16) at an angle with respect to an interior surface of tubular screen and mandrel 16. The angle is related to the conical angle formed on substantially flat surface 60 of welding wheel 18. It is seen that welding wheel 18 extends through slot 14 for engaging the interior surface of the tubular screen. While a substantially flat surface is shown for welding wheel 18 here, other possible surfaces such as rounded, elliptical, multiple rounded surfaces, and the like may also be utilized. Flat surface 60 is almost as wide as slot 14 thereby providing significant support for the filter material. If desired, the edges of slot 14 may be angled to more closely fit to the angle of inner welding wheel 18, i.e. the angle of the edges of slot 14 may be the same as the angle of wheel top 72 of inner welding wheel 18 with respect to the interior wall of mandrel 16.

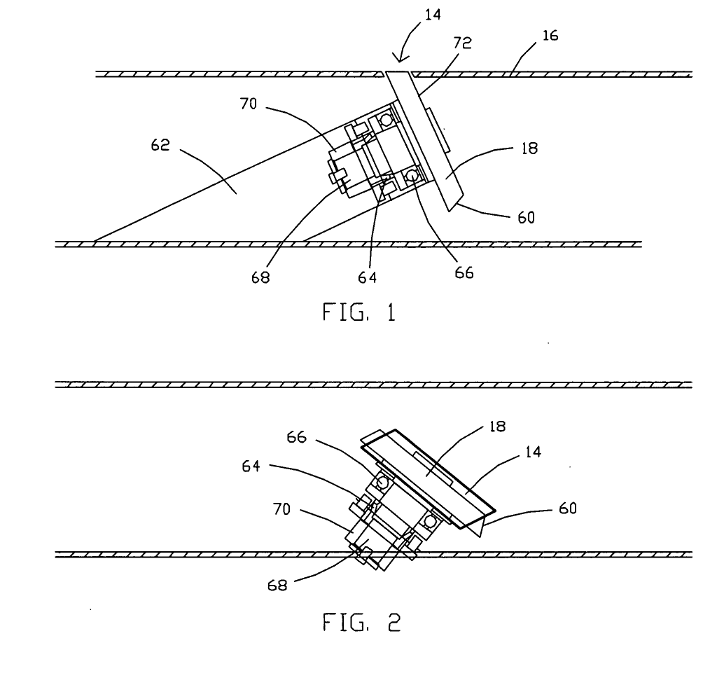

In this embodiment, support 62 connects to inner welding wheel 18 via roller bearings 64 and 66 which may also comprise thrust bearing support. Electrical current may be applied to shaft 68 via cylinder 70 or other type of current supply connection. As noted earlier, inner welding wheel 18 may be electrically shorted to mandrel 16 or may be connected to electrical power as desired or may utilize no cable at all. FIG. 2 shows welding wheel 16 looking down from the top or in a plan view wherein slot 14 and welding wheel 16 are aligned with the seam between the filter material strips which is angled at 45 degrees. While a preferred embodiment of slot 14 is curved as discussed below, it is also possible that in some constructions, slot 14 might be straight or substantially straight as viewed from the top as indicated here, wherein slot 14 is also shown somewhat wider.

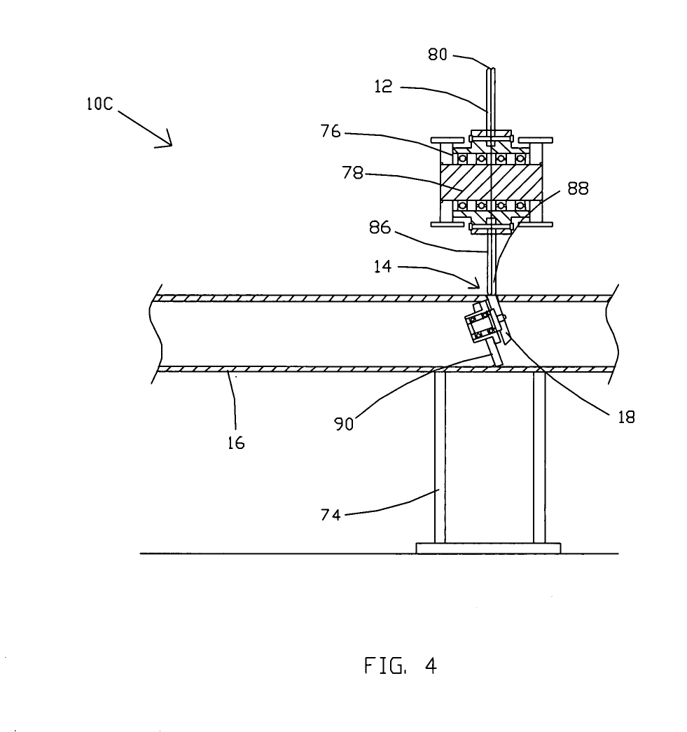

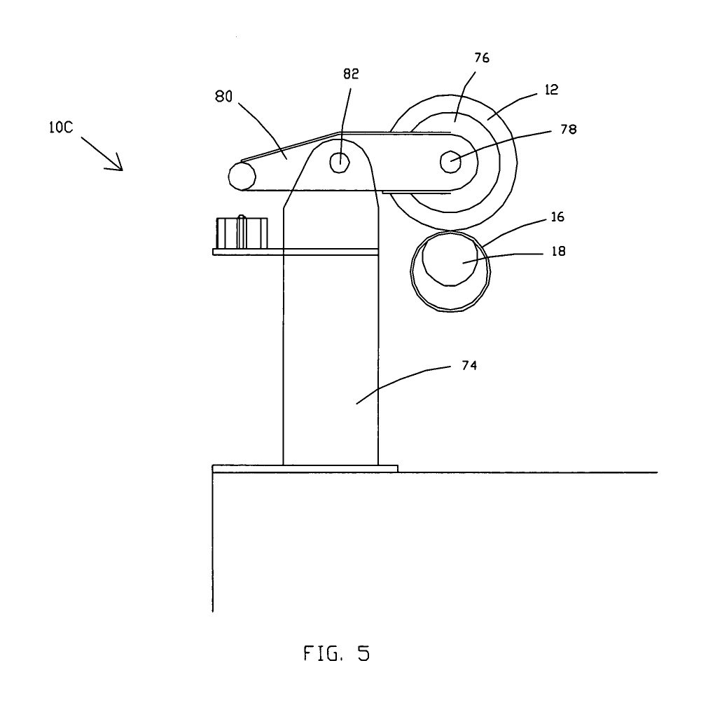

FIG. 4 schematically shows relevant portions of tubular filter material construction machine 10C comprising dual outer welding wheels 12, a single inner welding wheel 18, mandrel 16, and support stand 74 in accord with one possible embodiment of the present invention.

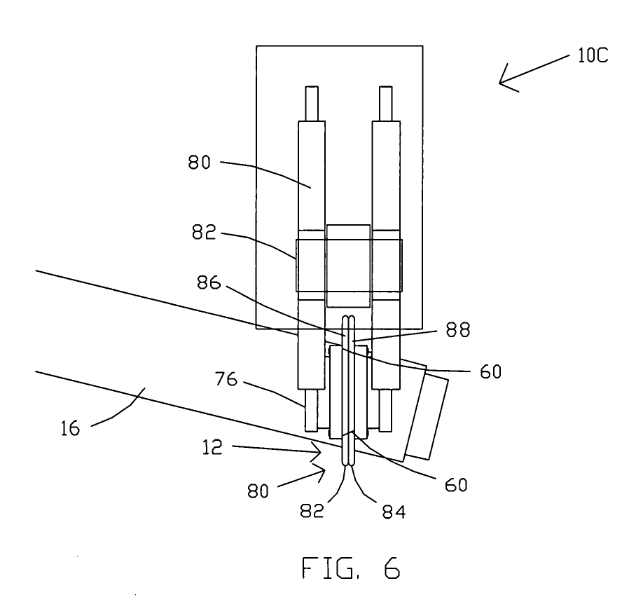

Outer welding wheel 12 may comprise wheel support and bearing assembly or hub assembly 76 which rotates around shaft 78. In this embodiment, outer edge 80 of outer welding wheel 12 comprises two disks 86 and 88 with outer rounded edges 82 and 84, as perhaps better seen FIG. 6. In this embodiment, the two rounded edges 82 and 84 engage a relatively flat or straight outer surface of inner wheel 18 such as straight conical surface 60 shown in FIG. 1. The two relatively flat disks 86 and 88 with rounded outer surfaces 82 and 84 may be separately bolted or otherwise secured on hub 76. In this embodiment, flat disks 86 and 88 are electrically insulated from each other to provide an electrical current path as described below. Current feed to flat disks 86 and 88 may comprise sliding, rolling, and/or spring-loaded electrical contacts as desired.

While two rounded disks are shown in FIG. 4, more or fewer may also be utilized. Moreover, outer welding wheel 12 may have a flat or straight outer surface as desired and/or inner welding wheel 18 may have a flat or straight or curved or multiple curved surfaces. Inner welding wheel 18 in this embodiment may be mounted with bearings on support 90.

FIG. 5 is an end view of FIG. 4 along lines 5-5 with some additional structures provided. In this example, support arm 80 may be rotatable around hinge 82 to thereby raise and/or lower outer wheel 12 for engagement with the outer surface of the filter material strips to be welded together.

FIG. 6 shows a possible plan view of the mounting for outer wheel 12. It will be noticed in the drawing of FIG. 6 that the outline of inner wheel 18 is superimposed such that straight conical surfaces 60 are seen and inner wheel 18 is otherwise aligned with outer wheel 12. If desired, arm 80 may be adjustable to move outer wheel closer to or away from mandrel 16. The relative angle of mandrel 16 and outer wheel may be adjusted as desired to track the seam for welding the strips of filter material together.

In one possible electrical configuration for the embodiment of tubular filter material construction machine 10C, inner wheel 18 acts to short together the two disks 86 and 88 which form outer welding wheel 12. Because inner welding wheel 18 is not electrically driven in this possible embodiment, there is no need to connect a cable to welding wheel 18 inside mandrel 16 for electrical welding current. For this electrical configuration, resistance-welding may be accomplished by maintaining the two insulated disks 86 and 88 on the outside of mandrel 16 at different electrical potentials whereby surface 60 of inner roller or welding wheel 18 acts as a shorting bridge. In this case, current-flow is from a first of the disks 86 and 88 through the mesh layers to relatively flat surface 60 of inner welding wheel 18 in mandrel 16 and back through the mesh to the second disk. In this way, two continuously welded spiral seams may be formed. However, it may be more desirable to utilize this configuration when fewer filter material layers are utilized, for instance, depending on the mesh, when less than two filter material layers form the mesh tubular screen to be created.

In another electrical configuration, current-flow may be directed to both disks 86 and 88 of outer welding wheel 12 to inner welding wheel 18 inside mandrel. Again, two current paths are formed which may produce two continuous welded seams. In this embodiment, at the end of the shaft of inner welding wheel 18, a sliding rotary contact such as rotary contact 58 shown in FIG. 3 or rotary contact 70 shown in FIG. 1.

In one possible embodiment, a cooling system (not shown) may be utilized for cooling the assembly of inner welding wheel 18. Either air cooling or fluid cooling such as water may be utilized. Such cooling will also help to avoid loss of hardness of the welding bronze. For instance, water may be directed or pumped through tubulars to a cooling tank, spray, rotary connections, or the like, for inner welding wheel 18.

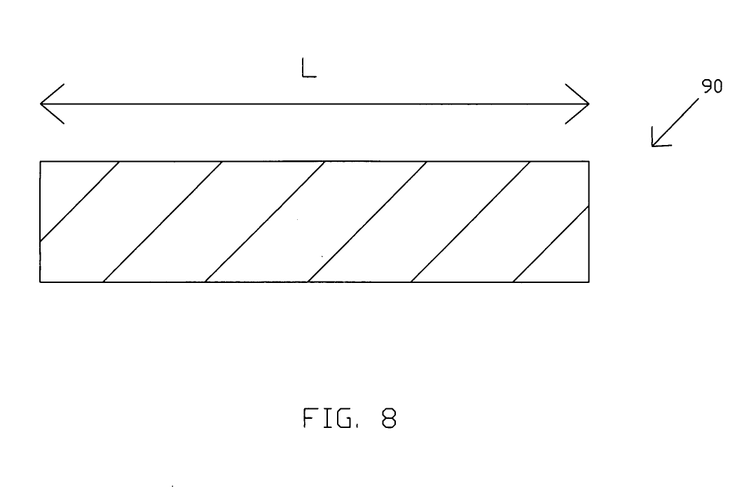

The resulting woven mesh or filter material tubular screen 90 may have any desired length L as indicated in FIG. 8. Tubular screen 90 may be cut off to the desired length as it comes off of the woven mesh tubular construction machine discussed hereinbefore. The resulting spiral wound tubular 90 is free standing without the need for internal supports. Thus, if made of spirally welded woven mesh, tubular screen 90 may be inspected by passing inspection lighting through the interior of the woven tubular mesh to verify quality construction. Tubular screen 90 may be used in new applications suitable only for free-standing tubular screens of any length so as to permit quality inspections and/or to reduce the costs associated with prior art tubular filter material screens. The resulting woven mesh tubular screen 90 may also be used in place of more expensive tubular screens which are made by the laborious prior art methods such as those made with longitudinal seams as discussed hereinbefore. Moreover, tubular screen 90 may be quite long so as to replace multiple tubular screens that were welded together endwise in the prior art to thereby provide a better filter continuous screen at a lower cost.

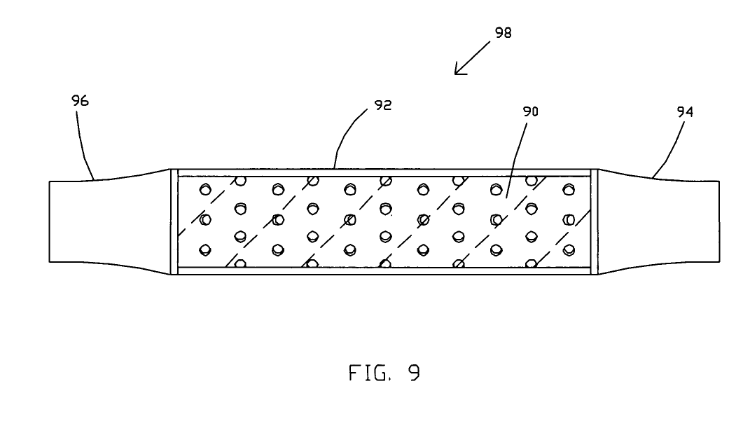

As an example of use, tubular 90 may be used with downhole sand control filter 98 of any length shown very generally in FIG. 9. For instance, tubular screen 90 may, if desired, be positioned inside of perforated tubular 92 by sliding a desired length of continuously formed tubular screen 90 therein. Tubular screen 90 is then held in position within sand control filter 98 with end caps 94 and 96 which may be adapted to connection to pipe strings or the like for lowering into well bores. In this case, the maximum outer diameter of tubular screen 90 and perforated tubular 92 is limited to that of the wellbore through which it must be passed prior to being positioned at the zone of interest, generally less than about 18 inches and often smaller diameter but of any desired length. If desired, tubular screen 90 may also be slid onto perforated interior tubulars such as perforated tubing, drill pipe, or the like, after being inspected to very quality. For downhole sand control purposes, it is normally desirable to utilize a continuous spiral weld in tubular 90 to avoid leakage between discontinuities of the spiral weld. Spiral wrapped screen 90 can be made at one location and shipped to any location for quality inspections and/or for combining with perforated tubular 92, which may be made elsewhere. Alternatively, the tubular filter construction machine 10 can be brought to a desired location so that sand control filter screen 98 is built at the desired location.

Downhole sand control filter 98 may, if desired, be used without an interior perforated screen in contrast to some prior art devices discussed herein before which have additional blocked regions. The resulting downhole sand control filter 98 has maximized open areas to provide for maximum flow. Offsetting material or wire may be utilized between perforated tubular 92 and tubular 90 if desire.

Filter material tubular screen 90 may also be utilized for other filtering purposes including for filtering screens used in surface filtering systems which may comprise multiple replaceable cartridges. Sections of tubular screen 90 may also provide low cost sifting tubes. The woven mesh tubular screen 90 may comprise numerous variations. Various types of screens may be utilized, e.g., the screen openings may vary from one-half inch to three microns.

In another embodiment, spiral wrapped tubular screen 90 may be used in an extruder as a molten plastic extruder screen. In accord with the present invention, spiral wrapped wire mesh tubular extruder screens can be built much faster and more cheaply that presently existing molten plastic extruder screens.

In another embodiment, filter material tubular 90 may comprise spiral wound continuous or non-continuously welded filter cores made using wire mesh or plastic mesh and cut off to length. Thus, for instance, filter material tubular 90 may be utilized as low cost car filter cores or other engine filter cores. In another embodiment, tubular filter material screen 90 may be utilized as a cylindrical vibrating screen. In another embodiment, tubular filter material screen 90 may be utilized as sound absorbers, extruder screens, filter membranes, and general purpose wire mesh tubes.

The present invention may utilize various types of filter materials or combinations thereof and may comprise but is not limited to meshes such as hexagon mesh, metal fiber, plastic woven mesh, extruded mesh, weldable plastic fibers and other filter materials are commonly used in various filter screening applications. The filter material construction screen may utilize sheets of filter materials such as perforated or punched plastic or metal sheets. Although filter material may comprise woven filter material, plastic meshes, or the like, a non-limiting listing of examples of some of the various types of woven wire or mesh screens for use in accord with the present invention may be found in one or more previous patent applications such as U.S. patent application Ser. No. 10/157,537, entitled Filtering Screen Construction and Methods, filed May 29, 2002, which is incorporated herein by reference.

As well, many variations of a tubular filter material construction machine 10 are available. A preferred embodiment of tubular filter material construction machine 10 utilizes an electro-resistance weld which may be continuous or non-continuous. Various types of bonding devices and techniques and types of filter materials such as steel, wire mesh, plastics, papers, or the like, may also be utilized which may incorporate one or more constituents or types of bonding such as glue, bonding, ultrasonic welding, heat welding, and the like. Bonding devices could be implemented in place of or in conjunction with of the inner and outer welding wheels through slot 14 in mandrel 16 and preferably arranged for contacts on the inner sides and outer sides of the filter material. The tubular filter construction machine may also provide tack welds if desired. While a single slot or opening 14 is shown, it would be possible to provide a plurality of slots or openings in mandrel 16. Moreover a plurality of inner welding electrodes such as inner welding wheels could be utilized with the plurality of slots or openings. As noted above the slots or openings need not have a particular shape. Mandrel 16 may be comprised of steel, insulative materials and/or friction reducing materials, e.g. TEFLON, in whole or in sections or portions. In another possible embodiment, mandrel 16 or portions thereof may be moved or rotated with or without relative rotation of the filter material or portions thereof positioned on the mandrel. In another possible embodiment, one or more inner welding wheels 18 may be replaced one or more electrode plugs, rings, or rotating rings, formed on the outer surface of the mandrel which are insulated with respect to the remainder of the mandrel and which may also be water cooled. In another possible embodiment, mandrel 16 may be rectangular or square shaped or octagonal or shaped other than as a cylinder. The welding patterns may be continuous or discontinuous, with special patterns or arbitrary.

Accordingly, the foregoing disclosure and description of the invention is illustrative and explanatory thereof, and it will be appreciated by those skilled in the art, that various changes in the ordering of steps, ranges, and/or attributes and parameters, as well as in the details of the illustrations or combinations of features of the methods and apparatus discussed herein, may be made without departing from the spirit of the invention.

What is claimed is:

1. A machine for making a spiral wrapped filter material tubular screen from one or more strips of filter material, comprising:
a mandrel for receiving said one or more strips of filter material in spiral fashion around said mandrel to form a tubular configuration;
an inner bonding element positioned along an inner surface of said one or more strips of filter material arranged in spiral fashion around said mandrel; and
an outer bonding element positioned along an outer surface of said one or more strips of filter material arranged in spiral fashion around said mandrel, said outer bonding element cooperating with said inner bonding element to bond said one or more strips of filter material together.

2. The machine of claim 1, wherein said mandrel comprises a mandrel outer surface and defines an opening in said mandrel outer surface, said inner bonding element is positioned at said opening.

3. The machine of claim 1, wherein at least one of said inner bonding element or said outer bonding element comprises a wheel.

4. The machine of claim 1, wherein at least one of said inner bonding element or said outer bonding element comprises a welding electrode.

5. The machine of claim 1, further comprising at least one feed for at least one strip of insulating or friction reducing material.

6. A machine for making a spiral wrapped filter material tubular screen from one or more strips of filter material, comprising:
a mandrel comprising an outer surface;
at least one filter material strip feed to deliver one or more filter material strips onto said outer surface of said mandrel such that said one or more filter material strips are directed onto at least a portion of said outer surface of said mandrel for forming a shape of said filter material tubular screen, said one or more filter material strips comprising an exterior filter material surface facing away from said mandrel and an interior filter material surface facing said mandrel;
an exterior welding electrode positioned along said exterior filter material surface; and
an interior welding electrode positioned along said interior filter material surface, said interior welding electrode cooperating with said exterior welding electrode for welding said one or more wire strips together.

7. The machine of claim 6 wherein said mandrel further comprises a tubular, at least a portion of said interior welding electrode being positioned within an interior of said tubular.

8. The machine of claim 6 wherein said mandrel further comprises a mandrel opening in said outer surface of said mandrel, said interior welding electrode being positioned within said opening.

9. The machine of claim 8 wherein in said opening comprises a curved slot.

10. The machine of claim 8 wherein said interior welding electrode comprises at least one inner welding wheel.

11. The machine of claim 10, further comprising a drive for rotating said inner welding wheel to thereby spirally move said one or more filter material strips around said outer surface of said mandrel such that said one or more filter material strips are continuously spirally welded together.

12. The machine of claim 6 wherein said outer welding electrode comprises at least one outer welding wheel.

13. The machine of claim 6 further comprising a filter material strip drive which frictionally engages said one or more filter material strips to spirally wrap said one or more filter material strips around said mandrel and past said outer welding electrode and said inner welding electrode such that said one or more filter material strips are continuously spirally welded together.

14. A machine for making a spiral wrapped filter material tubular screen from one or more strips of filter material, comprising:
a mandrel comprising an outer surface and defining an opening in said outer surface around which spiral wrapped filter material is received;
an inner bonding element positioned at said opening; and
an outer bonding element which cooperates with said inner bonding element such to bond said one or more strips of filter material together whereby said spiral wrapped filter material tubular is moved continuously with respect to said mandrel.

15. The machine of claim 14, wherein said inner bonding element comprises a wheel.

16. The machine of claim 14, wherein said outer bonding element comprises a wheel.

17. The machine of claim 14, wherein said outer bonding element comprises one or more electrically insulated disks.

18. The machine of claim 14, further comprising at least one feed for feeding said one or more strips of filter material onto said mandrel.

19. The machine of claim 14, further comprising at least one feed for at least one strip of paper.

20. The machine of claim 14, wherein said opening comprises a curved slot.

21. A method for making a spiral wrapped filter material tubular screen from one or more strips of filter material, comprising:
wrapping said one or more strips of filter material spirally around a mandrel for forming a tubular shape of said spiral wrapped filter material tubular screen; and
spirally bonding said one or more strips of filter material such that a spirally bonded length of said spirally wrapped tubular screen moves axially with respect to said mandrel.

22. The method of claim 21, wherein said step of spirally bonding further comprises spirally welding said one or more strips of filter material together.

23. The method of claim 21, further comprising providing a desired length of said spiral wrapped filter material tubular screen with a desired length by cutting off a section of said spiral wrapped filter material tubular screen to said desired length.
